(19) United States
(12) Patent Application Publication
(10) Pub. No.: US 2016/0177041 A1
(43) Pub. Date: Jun. 23, 2016

(54) METHOD OF MANUFACTURING POLYMER COMPOSITE

(71) Applicant: NATIONAL CHUNG SHAN INSTITUTE OF SCIENCE AND TECHNOLOGY, Longtan Township (TW)

(72) Inventors: HSIN-PING CHANG, NEW TAIPEI CITY (TW); CHUN-HAN LIN, TAINAN CITY (TW); CHUNG-SUNG TAN, HSINCHU CITY (TW); CHUEN-MING GEE, HSINCHU COUNTY (TW); PAI-LU WANG, TAIPEI CITY (TW); CHING-JANG LIN, TAOYUAN CITY (TW)

(21) Appl. No.: 14/576,342

(22) Filed: Dec. 19, 2014

(51) Int. Cl. C08J 3/20

(52) U.S. Cl. CPC C08J 3/203; C08J 2363/00

(57) ABSTRACT

A method of manufacturing of a polymer composite includes the steps of (1) putting a nanofiller and a polymer material in a high-pressure device and eliminating air therefrom; (2) providing a gas in the high-pressure device and performing a heating and blending process on the nanofiller and the polymer material at a first pressure and a first temperature; (3) changing the pressure and temperature of the high-pressure device to a second pressure and a second temperature to thereby obtain a polymer composite; and (4) performing a degassing process on the polymer composite. Accordingly, the method is effective in manufacturing a polymer composite which includes a uniformly dispersed nanofiller.

### FIELD OF TECHNOLOGY

The present invention relates to methods of manufacturing a polymer composite, and more particularly, to a method of manufacturing a polymer composite which includes a uniformly dispersed nanofiller.

### BACKGROUND

Multifunction polymer composites have wide application in electronic engineering, aerospace engineering, and military technology and thus are intensely studied. In particular, polymer materials can contain a nanofiller with high thermal conductivity and high electrical conductivity so as to enhance the stress, thermal conductivity coefficient, and electrical conductivity of the polymer materials. However, due to the van der waals force between the layers of a nanofiller and the high viscosity of the polymer, it is quite difficult for a nanofiller to be uniformly dispersed and distributed in the polymer composites.

Chinese published patent application CN103552325 discloses as follows: disperse graphene in acetone, let the dispersed graphene in acetone undergo ultrasonic vibration at a power of 1000 W for 0.5 hour, introduce an epoxy resin and a carbon nanotube into the resultant graphene and acetone dispersion to form a mixture, stir the mixture with a magnetic blender for 0.5 hour, let the blended mixture undergo ultrasonic vibration at a power of 1000 W for 0.5 hour, put the well dispersed mixture in an oven for baking at 80° C. and for 10 hours, removing the acetone solution with a vacuum pump until the foam is gone, adding an appropriate curing agent to the mixture, stirring the mixture with a magnetic blender for 20 minutes, and degassing with a vacuum pump, so as to produce a composite product by pressing.

U.S. Pat. No. 8,461,662 discloses a carbon-epoxy composition described below. 0.105 g of carbon black is added to 50 g of ethyl acetate, and then the mixture undergoes ultrasonic oscillation for 30 minutes to obtain carbon black dispersion. 1.577 g of bisphenol A diglycidyl ether (DGEBA), 0.246 g of dicyandiamide (DICY), and 0.015 g of 1-methyl imidazole are added to 10 g of ethyl acetate, and mixed with a magnetic blender for 30 minutes to provide an epoxy resin solution. The two are put in the same container and then stirred with a magnet for 30 minutes, wherein the two are processed with a homogenizer every three minutes and by ultrasonic vibration thrice every three minutes. Then, ethyl acetate is removed from the mixture in a vacuum environment and at 32° C., so as to obtain a carbon/epoxy resin composite with viscosity of 100,000 cps.

The above-mentioned conventional polymer material dispersion technique requires reducing the viscosity of a polymer material through a large amount of an organic solvent and surface modification of a nanofiller so as to disperse a nanofiller in the polymer composite. However, with environmental consciousness among people nowadays increasing, there is widespread concern about enormous use of organic solvents, which causes environmental pollution. Also, during their manufacturing processes, organic solvents are likely to be harmful to workers, not to mention that residual organic solvents have a negative influence on the lifetime of polymer composites.

In view of this, it is important for the industry to provide a manufacturing method which reduces the viscosity of a polymer material without any organic solvent, such that the method applies to disperse a nanofiller uniformly in the polymer composite to thereby achieve a balance between environmental protection and process efficiency and ensure that a nanofiller are uniformly dispersed in the polymer composite thus manufactured.

### SUMMARY

In view of the above-mentioned drawbacks of the prior art, it is an objective of the present invention to provide a method of manufacturing a polymer composite so as to integrate a high-pressure device, a nanofiller, a polymer material, a heating and blending process, and a degassing process, achieve a balance between environmental protection and process efficiency, and ensure that the polymer composite thus manufactured includes a uniformly dispersed nanofiller.

In order to achieve the above and other objectives, the present invention provides a method of manufacturing a polymer composite, comprising the steps of: (1) putting a nanofiller and a polymer material in a high-pressure device and eliminating air therefrom; (2) providing a gas in the high-pressure device and performing a heating and blending process on the nanofiller and the polymer material at a first pressure and a first temperature; (3) changing the pressure and temperature of the high-pressure device to a second pressure and a second temperature so as to obtain a polymer composite; and (4) performing a degassing process on the polymer composite.

The nanofiller comprises a graphene, a carbon nanotube, a fullerene, a vapor grown carbon fiber, a carbon nanofiber, nickel, boron, copper, iron, silicon carbide, silicon oxide, aluminum oxide, or a mixture thereof, and has a particle diameter of 0.1˜500 nm. The polymer material is polymethyl methacrylate (PMMA), epoxy resin, phenolic resin, polycarbonate, polyimide, polyethylene terephthalate, polyvinyl chloride (PVC), polypropylene (PP), acrylonitrile-butadiene-styrene (ABS) copolymer, polystyrene, or a mixture thereof.

In step (2), the gas provided in the high-pressure device is carbon dioxide, but the present invention is not limited thereto, wherein the gas flow is maintained at 0.5˜5.0 L/min, and the gas turns into a supercritical fluid as soon as the first pressure and the first temperature in the high-pressure device reach 75˜250 atm and 35˜65° C., respectively. Furthermore, in step (2), the heating and blending process is carried out at a stirring speed of 50˜500 rpm and for a stirring duration of 0.5˜5 hours to enable the supercritical fluid to mix the nanofiller uniformly with the polymer material.

In step (3), for example, the second pressure is a normal pressure, and the second temperature is a normal temperature, wherein the second pressure is less than the first pressure, and the second temperature is less than the first temperature.

In step (4), the gas is removed from the polymer composite by a degassing process, preferably a vacuum degassing process. For example, the polymer composite is put in a vacuum environment of 0.1˜1.0 Torr to undergo the degassing process for removing the gas therefrom.

To render the features and advantages of the present invention more obvious and comprehensible, the present invention is hereunder illustrated with specific embodiments, drawings, and a detailed description.

### BRIEF DESCRIPTION

Objectives, features, and advantages of the present invention are hereunder illustrated with specific embodiments in conjunction with the accompanying drawings, in which:

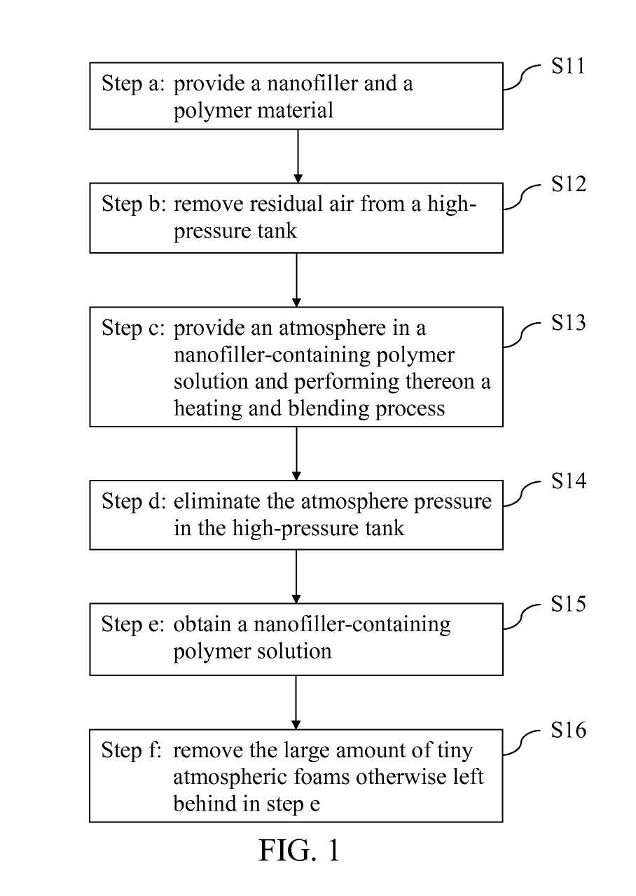

FIG. 1 is a flow chart of a method of manufacturing a polymer composite according to an embodiment of the present invention.

### DETAILED DESCRIPTION

A supercritical fluid is operated at a temperature and a pressure which are above its critical temperature and critical pressure. The physical properties of a supercritical fluid manifest in a way between that of a gas phase and that of a liquid phase, its viscosity approximates to that of a gas, and its density to a liquid's. In this regard, after separation or a reaction, a carbon dioxide supercritical fluid is operated at a temperature near the room temperature, and it can be easily separated from the other substances by decompression, and in consequence it is unlikely to remain and cause any problems with environmental protection and safety.

Gas has greater swelling, extraction, and permeation ability toward polymeric materials than conventional organic solvents, allowing it to be used in polymer foaming, for extraction of residues from polymers, and for impregnation of additives into polymers. Hence, the interaction between a supercritical fluid and a polymer is deemed an important indicator of application. As regards the correlation between the polymer material and the supercritical fluid in terms of solubility, in general, the solubility of the supercritical fluid in the polymer material not only increases with the polar groups in the polymer but also increases with pressure. When a polymeric material absorbs a certain amount of gas, the entanglement of the polymer chains is weakened, increasing the free volume between them and, thereby, decreasing the glass transition temperature (T_{g}), viscosity, and surface tension of the polymer. The solubility of gas in a polymer is proportional to the content of polar functional groups in the polymer structure and the operating conditions. Hence, the present invention is advantageously characterized in that the above-mentioned feature is conducive to increasing the chance of introducing a nanofiller into a polymer material during the process of preparing the composite by means of the supercritical fluid.

Referring to FIG. 1, there is shown a flow chart of a method of manufacturing a polymer composite according to an embodiment of the present invention. As shown in FIG. 1, the process flow of the method according to an embodiment of the present invention comprises six steps, that is, step a (S11) through step h (S16). Step a involves providing a nanofiller and a polymer material (S11), wherein the nanofiller is selectively a nanoscale carbon material, including a graphene, a carbon nanotube, a fullerene, vapor-grown carbon fiber, carbon nanofiber or nanoscale metal particles of nickel, boron, copper, iron, or nanoscale ceramic material of silicon carbide, silicon oxide, and aluminum oxide. The polymer material is selectively polymethyl methacrylate (PMMA), epoxy resin, phenolic resin, polycarbonate, polyimide, polyethylene terephthalate, polyvinyl chloride (PVC), polypropylene (PP), acrylonitrile-butadiene-styrene (ABS) copolymer, polystyrene, or a mixture thereof. Both the nanofiller and the polymer material are simultaneously put in a high-pressure tank, wherein the nanofiller accounts for 10˜60 wt % of the polymer material contains. Since the polymer material possesses a high viscosity coefficient but low fluidity, the non-uniform dispersion of the nanofiller, due to its aggregation, ends up in agglomerates that disrupt the fluidity of the epoxy resin, resulting in the formation of defects. Step b involves removing residual air from the high-pressure tank (S12), wherein the duration of removal is 1˜5 minutes, depending on the quantity of the nanofiller and the quantity of the polymer material, and the removal process will not stop unless and until there is no more air in the high-pressure tank. Step c involves providing an gas in a nanofiller-containing polymer solution and performing thereon a heating and blending process (S13), wherein the gas is selectively carbon dioxide, but the present invention is not limited thereto, so as to keep the flow rate at which the carbon dioxide is introduced into the high-pressure tank at 0.5˜5.0 L/min, keep the pressure in the high-pressure tank at 75˜250 atm, keep the temperature in the high-pressure tank at 35˜65° C., keep the stirring speed at 50˜500 rpm, and keep the stirring duration at 0.5˜5.0 hours. Step d involves changing the gas pressure in the high-pressure tank to a normal pressure (S14), wherein the gas flow is maintained at 50˜500 c.c./min. Step e involves obtaining a nanofiller-containing polymer material (S15), wherein the gas is not completely removed from the polymer solution, and, as a result, the solution contains a large amount of tiny gas bubbles. Step f involves removing the large amount of tiny gas bubbles otherwise left behind in step e (S16), followed by putting the nanofiller-containing polymer material in a vacuum oven, keeping the operating environment at a vacuum pressure of 0.1˜1.0 Torr, keeping the operating duration at 0.5˜8.0 hours, and keeping the operating temperature at 30˜60° C. unless and until there is no more tiny gas bubbles in the nanofiller-containing polymer material.

Referring to Table 1, there is shown a table for comparing the present invention with the prior art in terms of the electrical conductivity of a nanofiller-containing polymer composite thus manufactured. As shown in Table 1, the manufacturing of both polymer composite No. 1 and polymer composite No. 3 is carried out by a conventional blending process which entails diluting a polymer material with a solvent, such as acetone. Both polymer composite No. 1 and polymer composite No. 3 are manufactured according to the prior art from the same polymer material and nanofiller, i.e., epoxy resin and graphene, as the preferred embodiments of the present invention embodiment do. The manufacturing of both polymer composite No. 1 and polymer composite No. 3 is carried out by a heating and blending process in the presence of a solvent, at 40° C., and for 12 hours. Afterward, an epoxy resin and the curing agent (of a ratio of 3:1) are poured in a mold to cure at a normal temperature for 6 hour and then cure at 50° C. for two hours, so as to manufacture the polymer composite. The manufacturing of polymer composite No. 1 requires 4.5 wt % of nanofiller to therefore achieve the electrical conductivity of 3.81×10⁻¹⁰ (S/cm). The manufacturing of polymer composite No. 3 requires 7.7 wt % of nanofiller to therefore achieve the electrical conductivity of 3.20×10⁻⁹ (S/cm). Both polymer composite No. 2 and polymer composite No. 4 are manufactured from a polymer material are swelled with a supercritical fluid according to an embodiment of the present invention, wherein an epoxy resin functions as the polymer material, and a graphene as the nanofiller, and, to be specific, are manufactured by the heating and blending process temperature at 40° C. or so, under 100 atm or so, for 2 hours, and in the presence of an appropriate amount of a curing agent, wherein the epoxy resin to curing agent ratio is 3:1. Afterward, the epoxy resin and the curing agent are put in a mold to cure at a normal temperature for 6 hours and then cure at 50° C. for 2 hours to manufacture the polymer composite. The manufacturing of polymer composite No. 2 requires 4.5 wt % of nanofiller to therefore achieve the electrical conductivity of 1.47×10⁻⁹ (S/cm). The manufacturing of polymer composite No. 4 requires 7.7 wt % of nanofiller to therefore achieve the electrical conductivity of 1.64×10⁻⁸ (S/cm). The above-mentioned comparison verifies that the present invention, which entails swelling a polymer material with a supercritical fluid, is effective in enhancing the efficacy of stirring a nanofiller in the polymer material without leaving a trace of solvent.

TABLE 1
comparison of electrical conductivity

| | | electrical |
|---|---|---|
| polymer composite number | nanofiller (wt %) | conductivity (S/cm) |
| 1 | 4.5 | 3.81 × 10⁻¹⁰ |
| 2 | 4.5 | 1.47 × 10⁻⁹ |
| 3 | 7.7 | 3.20 × 10⁻⁹ |
| 4 | 7.7 | 1.64 × 10⁻⁸ |

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A method of manufacturing a polymer composite, comprising the steps of:
(1) putting a nanofiller and a polymer material in a high-pressure device and eliminating air therefrom;
(2) providing a gas in the high-pressure device and performing a heating and blending process on the nanofiller and the polymer material at a first pressure and a first temperature;
(3) changing the pressure and temperature of the high-pressure device to a second pressure and a second temperature so as to obtain the polymer composite; and
(4) performing a degassing process on the polymer composite.

2. The method of claim 1, wherein the nanofiller comprises one of a graphene, a carbon nanotube, a fullerene, a vapor-grown carbon fiber, a carbon nanofiber, nickel, boron, copper, iron, silicon carbide, silicon oxide, aluminum oxide, and a mixture thereof.

3. The method of claim 1, wherein the nanofiller is of a particle diameter of 0.1˜500 nm.

4. The method of claim 1, wherein the polymer material is one of polymethyl methacrylate (PMMA), epoxy resin, phenolic resin, polycarbonate, polyimide, polyethylene terephthalate, polyvinyl chloride (PVC), polypropylene (PP), acrylonitrile-butadiene-styrene (ABS) copolymer, polystyrene, and a mixture thereof.

5. The method of claim 1, wherein the atmosphere is carbon dioxide.

6. The method of claim 1, wherein the first pressure is 75˜250 atm.

7. The method of claim 6, wherein the first temperature is 35˜65° C.

8. The method of claim 1, wherein the second pressure is a normal pressure, and the second temperature is a normal temperature.

9. The method of claim 1, wherein the degassing process is a vacuum process.

10. The method of claim 9, wherein the vacuum process takes place at 0.1˜1.0 Torr.

11. The method of claim 1, wherein the gas flow is maintained at 0.5˜5.0 L/min.

12. The method of claim 1, wherein the heating and blending process is carried out at a stirring speed of 50˜500 rpm.

13. The method of claim 12, wherein the heating and blending process is carried out for a stirring duration of 0.5˜5 hours.
